(19) United States
(12) Patent Application Publication
(10) Pub. No.: US 2010/0211655 A1
(43) Pub. Date: Aug. 19, 2010

(54) ASSEMBLY COMPRISING A HANDHELD DEVICE

(76) Inventor: Soren Borup Jensen, Struer (DK)

Correspondence Address: HARNESS, DICKEY & PIERCE, P.L.C., P.O. BOX 8910, RESTON, VA, 20195, US

(21) Appl. No.: 12/734,143

(22) PCT Filed: Jul. 11, 2008
(86) PCT No.: PCT/EP2008/059083

§ 371 Date: Apr. 14, 2010

(30) Foreign Application Priority Data
Oct. 26, 2007 (DK) PA 2007 01535

(51) Int. Cl. G06F 15/16

(52) U.S. Cl. 709/219

(57) ABSTRACT

An assembly of a handheld device and one or more devices controllable by the handheld device and for providing events, such as audio/video/images to a user. The handheld device is adapted to receive streamed media information and stream the information to the providing means. Alternatively, the handheld device may instruct the providing means to receive the stream from another source. The handheld device may operate devices within a given distance and turn off devices farther away.

The present invention relates to data exchange between a remote control and a remote controllable apparatus and in particular to an apparatus having an archive of and/or access to data files with media information, which data may be received by the remote control and/or transferred to another remote controllable apparatus for rendering by the receiving apparatus.

Systems comprising wireless communication of audio may be seen in WO 2004/098079 and WO 2007/101218.

In a first aspect, the invention relates to an assembly of a handheld device, a media transmitter and a media provider, wherein:
the media transmitter is adapted to wirelessly stream media information,
the handheld device is adapted to:
   receive instructions from a user and to output corresponding information and
   receive streamed media information from the media transmitter and output corresponding, streamed media information,
the media provider is adapted to:
   receive the corresponding information from the handheld device and act accordingly and
   receive the corresponding, streamed media information from the handheld device and simultaneously provide this to the user.

In the present context, a handheld device may be any type of element small and light enough to be held in the hand(s) of a person and which is adapted to receive instructions from the user and output these to other equipment. Typically, the handheld device will be termed a remote control. Naturally, the device may be manipulated in any known manner by the user, such as using any type of manipulatable element, such as push buttons, potentiometers, touch pads/screens, rotatable or otherwise movable/displaceable elements, a camera combined with image analysis software, a microphone combined with speech recognition means, an accelerometer, or the like.

According to the invention, the handheld device is able to, in addition to receiving instructions from the user and outputting corresponding information, receive streamed media information from the media transmitter and output corresponding, streamed media information. Thus, the present handheld device is adapted to, in real time, thus the streaming, receive and output the media information. This will mean that the handheld device will not receive a full media file and subsequently transmit this to a providing means. According to the invention, the receipt of a media file and the output of a corresponding media file will take place (at least for a part of the file) simultaneously.

Streaming of an audio file means that while providing/playing part of the audio file, other parts thereof are transmitted to the providing element. The same applies to all other types of media files.

In this manner, the handheld device has a number of advantages, as will be described further below.

Wireless interaction to/from the remote control device and from/to the media provider/transmitter may be based upon standard wireless means like: RF, HF, Bluetooth, Wifi, Wireless LAN and/or infrared (IR).

Naturally, the media transmitter—or multiple media transmitters, may transmit more than one stream of media information, where the handheld device may then be used for selecting one of the streams.

A plurality of audio/video media file formats exists, such as audio, video, images/pictures or the like, and may be received, processed and transferred to an apparatus under control. Examples of media files are, but not limited to: podcast, music, e.g. MP3, MP4, WMA and video e.g. AVi, MPEG and text and graphic/photo e.g. PDF and JPEG. In addition, media information may comprise not only the audio/video/image/text to be provided to the user, but also additional information, normally termed meta data which describe the “main” information or provide additional information thereto. Thus, a video file may have meta data describing the author/performer/actor/production year/label or the like, and may also comprise e.g. an image which is the poster or front side of the video, as is also known from CDs today.

In the present context, a media transmitter may be a remote PC/server or portal residing on a network, the network being a LAN, a WAN or the Internet. Media files may reside on the server/portal organized in dedicated folder structures. Alternatively, the transmitter may be a CD/DVD-player, or any other signal source, such as an access directly to the WWW and streamed media information available from that source, such as streamed radio channels, streamed information from Youtube or the like. Usually, a plurality of such sources will exist with a single element combining the available media files so that the user, via the remote control, will have an easy overview of the available events or media files.

In one embodiment, a media provider may also be a media transmitter, if the media provider is adapted to not only provide media to the user but also has access to media, such as a TV combined with a DVD player or a TV tuner, or speakers combined with a CD player. Such media may then be streamed to the handheld device and further on to other providing means. Thus, a large number of different media providers may easily be contemplated.

In the present context, a media provider may be any type of equipment which is adapted to provide media information to the user. A wide variety of apparatus exist, such as Audio systems, radios, tuners, Video systems, TVs, DVD/CD/tape players/recorders, SDA memory players/archives, cameras, hard drives, computers, satellite boxes, PDAs, monitors, projectors, or the like.

In addition to being adapted to receive and provide the streamed media information, the media provider is adapted to receive the corresponding information and act accordingly. Such information and actions may relate to parameters related to the media information provided, such as the volume of provided audio, colour settings of provided video, the scrolling/shifting/changing/starting/stopping/deleting of chapters/parts/songs/pictures or the like in audio/video/text/images, or the like.

In addition, the information and actions may be the turning on or off of the media provider, altering physical parameters thereof (physical rotation, opening of access areas or the like), selecting media information source, if more than one media information stream is available, or if the media provider has access to other media sources, such as local sources (TV comprising a DVD player or TV tuner) or the like.

In one embodiment, the handheld device is adapted to receive information from the media transmitter and/or the media provider and act accordingly. In one situation, this information and acting relates to a status of the media transmitter/provider which may be transmitted to the handheld device and provided to the user via e.g. a display of the device. This status may be the actual operation of the means or the like.

In another situation, the information relates to media information available from the media transmitter, which information may be provided to the user on a display of the device or e.g. by playing parts of audio files or the like using a loudspeaker of the device.

In addition, the media transmitter/provider may inform the device of its capabilities, which information may be provided to the user either via a display or via enabling or disabling e.g. buttons on the device to inform the user whether the pertaining operations or capabilities are possible or not.

In another embodiment, the handheld device comprises means for processing the received, streamed media information to generate the corresponding media information. This processing may be the removal of parts of the information not required or desirable by the providing means, such as if the providing means is adapted to merely provide audio, removing video information from the streamed information. Also, the metadata may be removed if desired.

In another situation, settings of the information to be provided may be altered even in the handheld device instead of in the providing means (tone settings, volume, colour settings or the like). This has the advantage that if the stream is provided to multiple providing means, the same settings are more easily obtained across the providing means.

In another embodiment, the handheld device is adapted to provide the received, streamed media information to the user. This providing may be as that of the providing means. Alternatively, other types of providing may be performed by the handheld device, such as if the providing means are adapted to only provide a part of the streamed media information. In one situation, when streaming of a video file to a providing means only adapted to provide the image and not the sound, the sound may be provided by the handheld device. Alternatively, meta data relating to the streamed information may be provided by the handheld device, such as the image illustrating the album cover/poster may be provided on a display while the video/audio is provided by the providing means.

For example:
for audio files, when these are selected for play back, the meta information, e.g. a album cover of the music file may be displayed on device display means,
for video files, when these are selected for play back, optionally the video data itself is partly or fully displayed and the meta information, e.g. title header of the video file is displayed on device display means,
for picture/graphical files, when these are selected for play back, optionally the picture/photo/graphical data itself is partly or fully displayed and the meta information, e.g. title header of the picture file is displayed on device display means,
for text files when these are selected for play back, optionally the text data itself is partly or fully displayed and the meta information, e.g. title header of the graphical file is displayed on device display means.

According to another aspect, the invention relates to an assembly of a handheld device, a media transmitter and a plurality of media providers, wherein:
the media transmitter is adapted to wirelessly provide one or more streams of media information,
the handheld device is adapted to:
   receive instructions from a user as to an identified stream of media information from the media transmitter,
   identify one or more of the media providers in the vicinity of the handheld device and output information relating to the identified stream to the identified media providers,
each media provider is adapted to:
   receive the output information,
   receive the identified stream and
   provide the received stream to the user.

Naturally, a number of the elements of the first aspect may be used, but with slight changes.

According to this aspect, the media transmitter is adapted to wirelessly provide one or more streams of media information. Thus, the device may select which of these streams is to be provided.

Also, the handheld device is adapted to be used by the user to identify, using any of the means described further above, one of the streams, which the user desires to experience.

In addition, the handheld device is adapted to identify one or more of the media providers in the vicinity of the handheld device and output information relating to the identified stream to the identified media provider(s).

Each media provider within this vicinity is then adapted to receive the output information, receive the identified stream and provide the received stream to the user so that if the user moves around in a space, such as a house, with multiple providing means, the selected media stream may follow the user in that nearby providing means will be instructed to provide the stream, when the user approaches.

In this context, “in the vicinity” may be a maximum physical distance between the handheld device and the providing means or may be related to a minimum signal strength of a signal output by the provider or a maximum signal reduction/attenuation of the signal from the providing means. The vicinity may also be defined as a single room in a house.

In general, this term may be related to not only the physical distance but also the “acoustical” distance, for example, i.e. whether the user (holding the handheld device) is within hearing distance of the equipment, or whether a providing means providing visible information may be viewed by the user. Also, the “vicinity” may be determined by a strength of a signal output by the equipment and determined by the handheld device, or an attenuation of the signal output by the equipment.

Then, if the handheld device is moved into “the vicinity” of providing equipment, this equipment may, automatically, receive the instruction to, if required, turn on, and to receive and provide the identified stream.

In one embodiment, the handheld device is also adapted to:
identify media providers which provide the received stream to the user and which are not in the vicinity of the handheld device and
output deactivation instructions thereto, each media provider being adapted to, after having received deactivation instructions, not provide received media information to the user.

Consequently, in the opposite situation where the handheld device is moved away from a provider, this provider may be instructed to no longer provide the information. Also, the provider may be instructed to turn off.

In another embodiment:
the handheld device is adapted to receive additional instructions from the user and to output corresponding information to the media providers, and
each media provider, or at least those providing the received stream, is adapted to receive the corresponding information from the handheld device and act accordingly.

As mentioned in relation to the first aspect, this information and these actions may relate to starting/stopping/scrolling/skipping parts of the information streamed, altering characteristics or properties of the information provided or the like.

In another embodiment, the functionality of the first aspect, i.e. the streaming of the information via the handheld device, may be obtained by:
the handheld device is further adapted to receive the identified stream of media information from the media transmitter and stream the received stream to the identified media providers,
each media provider is adapted to receive the stream from the handheld device.

In yet another embodiment, as is also described in relation to the first aspect, the handheld device is adapted to receive information from the media transmitter and/or the media receiver(s) and act accordingly. This information and these actions may relate to the providing of the status of the provider/emitter or the like.

As is also described in relation to the first aspect, the handheld device may be adapted to provide the received, streamed media information to the user.

In addition, as is also described in relation to the first aspect, the handheld device may comprise means for processing the received, streamed media information to generate corresponding media information and output, as the output streamed information, the corresponding media information.

In the following, preferred embodiments of the invention will be described with reference to the drawing, wherein:

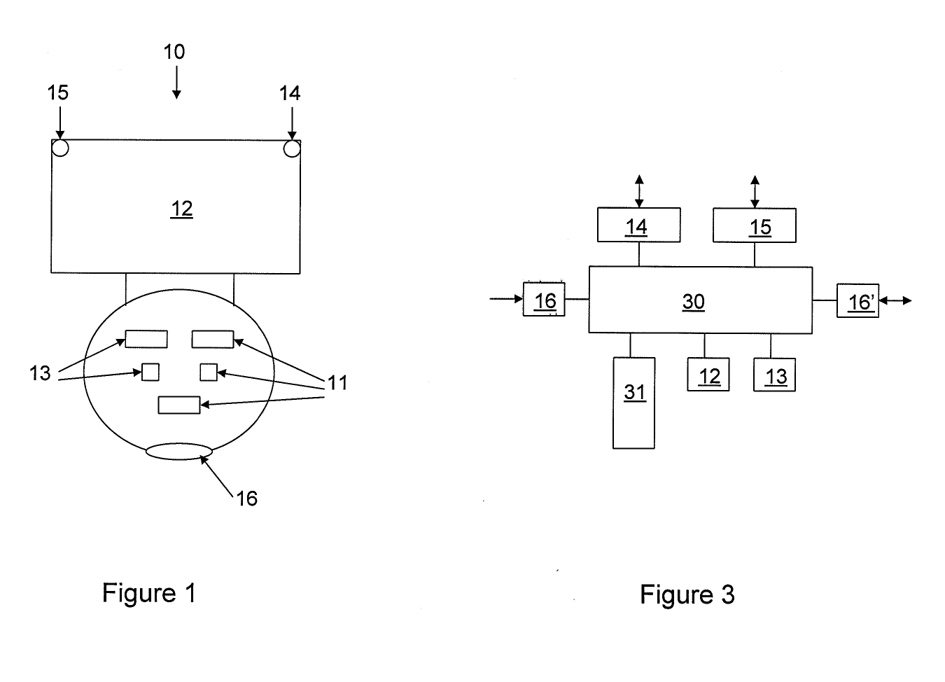

FIG. 1 illustrates a remote control,

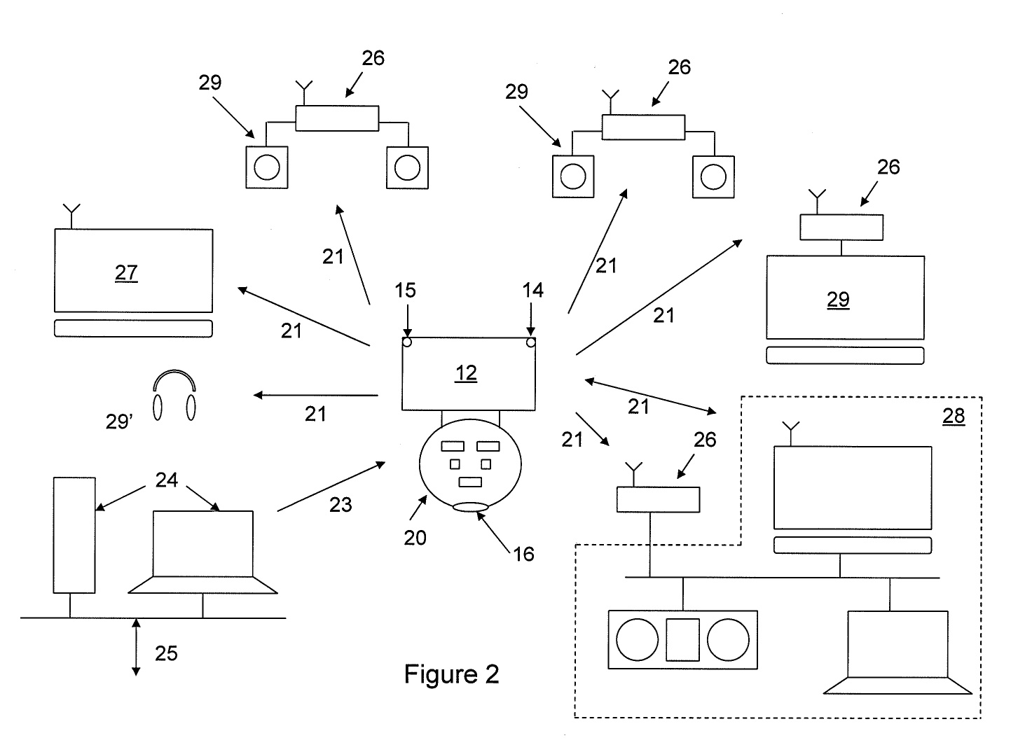

FIG. 2 illustrates the remote control, and its data exchange environment,

FIG. 3 illustrates a system block diagram of the remote control.

In FIG. 1, the remote control (10) has a display (12) and one or more buttons (11,13) for the user to control external remote apparatus via wireless signals (14) output from the remote control (10) as a result of the pushing of one or more of the buttons (11,13). The data communication channels are bi-directional to support commands being sent from the remote to the external equipment and to support reply data from the equipment, like apparatus status and data for interactive updates of the user interface on the display on the remote control.

The data communication means apply standard technologies like IR, RF and/or HF, and standard protocols for the data communication formats, e.g. a Bluetooth or WiFi may be applicable.

The remote control (10) has a data communication means to support the transfer of media to external remote apparatus via wireless signals (15). The output from the remote control (10) is a result of the pushing of one or more of the buttons (11,13). Data are streamed (21) from the remote controller to remote apparatus that may be distributed in a house in different rooms.

The remote control (10) has a physical connection means (16), e.g. a USB connector, or a proprietary connector enabling the device to receive power from an external power source, e.g. via a docking station.

In addition, the connection means (16) is configured with a data channel that enables the device to load digital media files from external data sources (24,25) into the memory means (31) of the remote control device (10). Standard means and protocols are applied in the load of data, supported by the command to a load of file from a data source.

In FIG. 2, it is seen how a remote control (20), which may be identical to that of FIG. 1, acts as a data transceiver in a data exchange environment. The remote control (20) communicates with a number of units 21-29 which are adapted to receive and/or transmit data in the form of streamed events and at least some of the units are adapted to provide streamed events to a user, such as by providing audio, video, images, or the like to the user.

The remote control (20) is loaded (23) with data via connection means (16) from a remote data source, such as a portal on the Internet (25) and/or a lap top computer and/or a PC server (24) accessible via a direct connection to the PC/laptop or via network connection means i.e. the portal or the PC/laptop.

Optionally, the loading of data (23) may be obtained via a wireless connection to the PC/laptop, if appropriate.

The loaded media data/files are fed into storage means (31) of the remote control (20). The user may view, arrange, rearrange, and edit the organisation of the media data into folders or any other user defined structures or play lists. The user may activate rendering of the individual files by commanding a play back of the specific file to be processed by means of the control unit (30).

The remote control (20) processes a received file according to the type of data contained in the file, and presents the relevant information for the user on the display means.

The remote control additionally is adapted to receive a streamed file from a media file provider and send the data file to the remote apparatus in terms of a data stream (21). This file may be transmitted to all remote apparatus. Optionally the data stream may be specifically addressed to individual remote apparatus.

The addressing scheme may be, but is not limited to:
issue an IR command addressed to one specific apparatus that a successive stream of data (RF) follows, and/or
issue a record containing both the address/identity of certain remote apparatus and data record, and issue the stream globally; thus only the addressed unit(s) react(s) on the data stream.

The remote apparatus (29) may be interconnected with standard data receiver means (26) to act as a connection bridge, e.g. via a Bluetooth connection, which forms an interface between the remote control (20) and the apparatus (29), which could be a speaker, a A/V media player, a TV set, and/or a PC/laptop.

A particular type of remote apparatus (29) may be active speakers directly connected to a connection bridge (26).

Another type of apparatus may be a headphone (29′) wirelessly accessed e.g. via Bluetooth.

Another remote apparatus (27) which is fitted with wireless connection means may be a TV set, which then may be supported identically to apparatus that are connected via the connection unit (26).

Seen from a user perspective, this system environment allows the user to move around in the house, carrying the remote control as an intelligent source of A/V media to be played back on the apparatus located in the room in which the user actually is. The remote control (20) is adapted to have the user determine which events or media files to provide, as these are streamed to the remote control (20), and to forward this/these to the apparatus desired, such as the apparatus which are in the room in which the user is. Thus, when entering a room, the remote (20) may automatically turn on any apparatus in the room and have the media file(s) streamed to this apparatus. In addition, when leaving a room, the remote (20) may turn off apparatus in that room.

Alternatively to the division of the overall space into rooms, the remote (20) may simply turn on/off equipment when at a predetermined distance from the remote (20), or a strength of signals output by which are below a given threshold, or have dropped a given percentage, dropped a given amount, or the like.

Naturally, the remote (20) may be used by the user to select the media stream, such as is known where the user selects an event, video, song or the like and instructs the media provider, such as a server or a DVD player to play this. Also, the remote may be used to alter the providing thereof (changing characteristics—volume, etc—thereof) which alterations may follow the remote (20) from room to room.

Also, the remote (20) may adapt the streaming to different apparatus depending on the capabilities of such apparatus, so that speakers receive only audio, but a TV may receive both audio and video, if both types of information are received by the remote (20) in the data stream received thereby.

In an advanced embodiment, the remote control device (20) has the full control capabilities of an A/V multimedia system (28), where the apparatus are interconnected via a network and to a connection bridge (26).

This configuration allows IR based control (22) of the A/V system, commanded from the remote control (20), and additional streaming (21) of media data that resides on the remote control (20).

In FIG. 3, a system block diagram of the remote control (10) is configured with a main control unit (30), and memory means (31) for storage of the media files and for storing data related to the user interface (UI) and for data related to the data communication means. The memory means may be a combination of disk, flash memory an RAM, all as standard devices.

The remote control is configured with a display (12), such as based on LCD, OLED, plasma or the like, and optionally a touch screen technology may be applied.

The remote control is configured with one or more command keys (11,13) like touch fields, push buttons, slider control, click wheels, or any other type of user friendly input means.

The remote control is configured with communication means (15) to support the control of the remote apparatus to command this to perform a specific function and or processing. Optionally the apparatus may respond with data to the remote control, correspondingly. The data communication means are standard means like IR or HF signals.

The remote control is configured with communication means (14) to support the control of the streaming of data to the remote apparatus to command this to perform a specific function and or processing. The data communication means are standard means like RF, HF signals.

This electrical contact (16) may be used for charging a battery of the remote control 10 and/or power operation of the remote control 10 while ‘docked’.

In addition, and especially when the remote control 10 is “docked”, the remote control 10 may have additional or replacement software uploaded via the load means (16′), and in fact the full operation thereof may be altered. In one situation, menu structures and/or hierarchies of the remote control may be amended or updated so as to have the remote control behave in a different manner.

A slightly different type of system is one in which the remote 10/20 does not directly receive a stream of one or more media files and stream this onwards to the providing equipment (speakers, TV's and the like), but select this in the same manner, but where the media provider which, in the above embodiment, provided the stream to the remote, now provides this wireless signal to the providing equipment. In this embodiment, the remote is used for instructing the individual providing equipment to provide the desired stream or not. Thus, the remote may, merely by being present in the same room or the vicinity, instruct equipment to turn on (if turned off) and to select and provide the stream identified by the remote. Naturally, in any of the embodiments described, a plurality of simultaneous streams may be provided, one of which is selected by the user using the remote and which is subsequently provided by the providing equipment.

In the latter embodiment, the remote may transmit a signal to the providing equipment which is desired to provide the stream, which signal identifies the stream, especially if multiple streams are available. Alternatively, the remote may instruct the element providing the stream to address the stream to certain providing equipment, which is in the vicinity of the remote, for example. In this manner, the providing equipment need not receive the ID from the remote, as the ID of the providing equipment is forwarded to the media file streaming element.

Naturally, as is the case in the first embodiment, the remote may be used for altering characteristics of the provided, streamed event or media file, either by instructing the providing equipment thereof as is known, or by instructing the media file streaming element to alter the streamed media file accordingly.

1. An assembly of a handheld device, a media transmitter and a media provider, wherein:
the media transmitter is adapted to wirelessly stream media information,
the handheld device is adapted to:
receive instructions from a user and to output corresponding information and
receive streamed media information from the media transmitter and output corresponding, streamed media information,
the media provider is adapted to:
receive the corresponding information from the handheld device and act accordingly and
receive the corresponding, streamed media information from the handheld device and simultaneously provide this to the user.

2. An assembly according to claim 1, wherein the handheld device is adapted to receive information from the media transmitter and/or the media provider and act accordingly.

3. An assembly according to claim 1, wherein the handheld device is adapted to provide the received, streamed media information to the user.

4. An assembly according to claim 1, wherein the handheld device comprises means for processing the received, streamed media information to generate the corresponding media information.

5. An assembly of a handheld device, a media transmitter and a plurality of media providers, wherein:
the media transmitter is adapted to wirelessly provide one or more streams of media information,
the handheld device is adapted to:
receive instructions from a user as to an identified stream of media information from the media transmitter,
identify one or more of the media providers in the vicinity of the handheld device and output information relating to the identified stream to the identified media providers,
each media provider is adapted to:
receive the output information,
receive the identified stream and
provide the received stream to the user.

6. An assembly according to claim 5, wherein the handheld device is adapted to:
identify media providers which provide the received stream to the user and which are not in the vicinity of the handheld device and
output deactivation instructions thereto, each media provider being adapted to, after having received deactivation instructions, not provide received media information to the user.

7. An assembly according to claim 5, wherein:
the handheld device is adapted to receive additional instructions from the user and to output corresponding information to the media players, and
each media provider is adapted to receive the corresponding information from the handheld device and act accordingly.

8. An assembly according to claim 5, wherein:
the handheld device is further adapted to receive the identified stream of media information from the media transmitter and stream the received stream to the identified media providers,
each media provider is adapted to receive the stream from the handheld device.

9. An assembly according to claim 5, wherein the handheld device is adapted to receive information from the media transmitter and/or the media receiver(s) and act accordingly.

10. An assembly according to claim 5, wherein the handheld device is adapted to provide the received, streamed media information to the user.

11. An assembly according to claim 5, wherein the handheld device comprises means for processing the received, streamed media information to generate corresponding media information and to output, as the streamed information, the corresponding media information.
